(19) United States
(12) Patent Application Publication
(10) Pub. No.: US 2026/0319405 A1
(43) Pub. Date: Oct. 15, 2026

(54) ELECTROPHOTOGRAPHIC MEMBER, FIXING DEVICE AND ELECTROPHOTOGRAPHIC IMAGE FORMING APPARATUS

(71) Applicant: CANON KABUSHIKI KAISHA, Tokyo (JP)

(72) Inventors: KOSUKE TANAKA, Chiba (JP); TOMOYO MIYAKAI, Tokyo (JP)

(21) Appl. No.: 19/466,854

(22) Filed: Feb. 2, 2026

(30) Foreign Application Priority Data
Feb. 13, 2025 (JP) 2025-021260
Jan. 7, 2026 (JP) 2026-001437

(51) Int. Cl. G03G 15/20

(52) U.S. Cl. CPC G03G 15/2057; G03G 15/206; G03G 15/2064

(57) ABSTRACT

An electrophotographic member comprising a substrate and an elastic layer provided on the outer circumference of the substrate, wherein the elastic layer comprises a rubber and fillers dispersed in the rubber, content of the fillers in the elastic layer is 15 to 50 volume %, content V_{A} of filler A in the elastic layer is 7 to 30 volume %, average aspect ratio of the filler A is 3.0 to 40.0, content V_{B} of the filler B in the elastic layer is 7 to 30 volume %, average aspect ratio of the filler B is 1.0 to 2.0, and an average orientation angle θ_{Ave} of the fillers having specific aspect ratio is 0° to 45°.

### BACKGROUND

### Field of the Technology

The present disclosure relates to an electrophotographic member used in a fixing device of an electrophotographic image forming apparatus, and a fixing device and an electrophotographic image forming apparatus which include the electrophotographic member.

### Description of the Related Art

Electrophotographic members such as fixing members used in fixing devices of electrophotographic image forming apparatuses such as printers, copying machines, and facsimiles have a film shape or a roller shape. As the fixing member, for example, one in which an elastic layer made of a heat-resistant rubber is formed as necessary on a film-shaped or roller-shaped substrate made of a heat-resistant resin or metal is known. In order for the elastic layer to exhibit high thermal conductivity, it is preferable to use a material in which an inorganic filler with high thermal conductivity is added as a filler in a rubber such as a silicone rubber.

In recent years, there has been a demand for additional performance improvements in electrophotographic image forming apparatuses, such as even faster print speeds, higher image quality, energy-saving performance, and support of a wider variety of media. In fixing devices, there is a demand for increasing the surface pressure in the fixing nip part in order to increase the amount of toner deformation and improve image quality. In addition, in fixing members, there is a demand for further improvement in the thermal conductivity in the thickness direction of the elastic layer of the fixing member.

However, when the amount of fillers added in the elastic layer is increased in order for the elastic layer to exhibit higher thermal conductivity, the elastic layer may break after long-term use, causing durability issues. Therefore, there is a need for a technique that improves thermal conductivity of the elastic layer without excessively increasing the filler content.

Japanese Patent Application Publication No. 2023-095891 discloses an electrophotographic member having an elastic layer containing small-particle-diameter fillers aligned in the thickness direction of the elastic layer and large-particle-diameter fillers not aligned in the thickness direction of the elastic layer. This allows the thermal conductivity to be improved without increasing the amount of fillers.

In addition, Japanese Patent Application Publication No. 2020-194156 discloses an electrophotographic member which contains, in a binarized image of a cross section of an elastic layer, first fillers having a major axis/minor axis of less than 1.5 and second fillers having a major axis/minor axis of 1.5 or more, wherein the second fillers are oriented in the thickness direction of the elastic layer. This allows the thermal conductivity to be improved without increasing the amount of fillers.

### SUMMARY

In Japanese Patent Application Publication No. 2023-095891, when fillers are aligned in the thickness direction to form a heat conduction path, the thermal conductivity can be improved compared to when fillers are not aligned in the thickness direction. However, in order to obtain higher thermal conductivity, it is necessary to increase the filler content to a certain level or more, and achieving both thermal conductivity and durability is a problem.

Therefore, when fillers having a high aspect ratio are oriented in the thickness direction of the elastic layer to form a heat conduction path, such as the second fillers in Japanese Patent Application Publication No. 2020-194156, high thermal conductivity can be obtained with a smaller filler content compared to when fillers having a low aspect ratio are used.

However, the inventors recognized that, when the electrophotographic member is used as a fixing member under conditions in which the maximum surface pressure of the fixing device in the fixing nip part is increased, there is a problem in achieving both thermal conductivity and durability even if fillers having a high aspect ratio are oriented in the thickness direction of the elastic layer.

The present disclosure provides an electrophotographic member having high thermal conductivity and high durability in which the elastic layer is less likely to break even after long-term use under conditions in which the maximum surface pressure in the fixing nip part is higher than in the past. In addition, the present disclosure provides a fixing device and an electrophotographic image forming apparatus which include the electrophotographic member.

The present disclosure relates to an electrophotographic member which is a rotating member comprising a substrate and an elastic layer provided on the outer circumference of the substrate, wherein the elastic layer comprises a rubber and fillers dispersed in the rubber, content of the fillers in the elastic layer is 15 to 50 volume %, when among the fillers, one having a particle diameter of 3 μm or more and less than 10 μm is defined as a filler A, and one having a particle diameter of 10 to 40 μm is defined as a filler B, content V_{A} of the filler A in the elastic layer is 7 to 30 volume %, average aspect ratio of the filler A is 3.0 to 40.0, content V_{B} of the filler B in the elastic layer is 7 to 30 volume %, average aspect ratio of the filler B is 1.0 to 2.0, when a plane of the elastic layer in a thickness-circumferential direction is defined as a first plane, and planes rotated from the first plane in increments of 10° toward the plane of the elastic layer in a thickness-axial direction are defined as second to tenth planes, cross-sectional images having a size corresponding to full thickness of the elastic layer×500 μm are acquired as first to tenth cross-sectional images such that the images are parallel to the first to tenth planes, and the center in a direction perpendicular to the thickness direction of the elastic layer matches the center of the electrophotographic member in the axial direction, the first to tenth cross-sectional images are binarized to form first to tenth binarized images, and in the first to tenth binarized images, when shapes of the fillers are approximated as ellipses, the fillers, which are approximately ellipses and have a major axis length/minor axis length value of 2.0 or more, have an average orientation angle θ_{Ave} of 0° to 45° relative to the thickness direction of the elastic layer.

The present disclosure relates to a fixing device, comprising: a fixing member; and a pressure member that faces the fixing member and forms a fixing nip part between the pressure member and the fixing member, through which a recording material carrying a toner image is nipped and transported, wherein at least one of the fixing member and the pressure member is the above electrophotographic member.

The present disclosure relates to an electrophotographic image forming apparatus comprising a fixing device, wherein the fixing device is the above fixing device.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view of an electrophotographic image forming apparatus.

FIG. 2 is a schematic view of a heat fixing device.

FIG. 3 is a schematic view of a fixing film.

FIG. 4A and FIG. 4B are a bird's-eye view and a cross-sectional view of a corona charging device.

FIG. 5 is a schematic view of first to tenth planes.

FIG. 6 is a schematic view of first to tenth cross sections.

### DESCRIPTION OF THE EMBODIMENTS

In the present disclosure, the description “from XX to YY” or “XX to YY” representing a numerical range means a numerical range including a lower limit and an upper limit, which are endpoints, unless otherwise specified. Also, when numerical ranges are described in a stepwise manner, the upper and lower limits of each of the numerical ranges can be arbitrarily combined. In addition, in the present disclosure, the description such as “at least one selected from the group consisting of XX, YY and ZZ” means any of XX, YY, and ZZ, a combination of XX and YY, a combination of XX and ZZ, a combination of YY and ZZ, or a combination of XX, YY, and ZZ. In the case where XX represents a group, a plurality of members may be selected from XX, and the same is true for YY and ZZ.

Hereinafter, embodiments of the present disclosure will be described in detail. Here, the technical scope of the present disclosure is not limited to the following description.

As described above, when the maximum surface pressure of the fixing device in the fixing nip part is increased, there is a problem in achieving both thermal conductivity and durability even if fillers having a high aspect ratio are oriented in the thickness direction of the elastic layer in the electrophotographic member. The inventors speculate the reason for this to be as follows.

When stress is applied to the elastic layer, since the fillers limit deformation of the rubber, stress concentration may occur near the fillers and microcracks may occur. Since severe stress concentration also occurs near the microcracks, if many microcracks occur in the elastic layer, they influence one another and grow into larger cracks. Since shear stress is applied to the elastic layer in the fixing nip part, it is thought that the above phenomenon occurs when the elastic layer breaks after long-term use of the fixing member.

In this case, as the aspect ratio of the filler is higher and the particle diameter is larger, stress concentration near the tip of the filler becomes more severe. In addition, as the distance between adjacent fillers becomes shorter, stress concentration becomes more severe. Therefore, it is speculated that, when fillers having a high aspect ratio are oriented in the thickness direction of the elastic layer, stress distribution in the elastic layer is likely to become non-uniform.

Under conditions in which the maximum surface pressure in the fixing nip part is high, if stress distribution in the elastic layer is non-uniform, local stress values become too high, causing many microcracks in the elastic layer. Therefore, it is thought that the elastic layer breaks after long-term use, causing a problem in durability.

The inventors conducted extensive studies and found that the following configuration can achieve both thermal conductivity and durability.

The present disclosure relates to an electrophotographic member which is a rotating member comprising a substrate and an elastic layer provided on the outer circumference of the substrate, wherein the elastic layer comprises a rubber and fillers dispersed in the rubber, content of the fillers in the elastic layer is 15 to 50 volume %, when among the fillers, one having a particle diameter of 3 μm or more and less than 10 μm is defined as a filler A, and one having a particle diameter of 10 to 40 μm is defined as a filler B, content V_{A} of the filler A in the elastic layer is 7 to 30 volume %, average aspect ratio of the filler A is 3.0 to 40.0, content V_{B} of the filler B in the elastic layer is 7 to 30 volume %, average aspect ratio of the filler B is 1.0 to 2.0, when a plane of the elastic layer in a thickness-circumferential direction is defined as a first plane, and planes rotated from the first plane in increments of 10° toward the plane of the elastic layer in a thickness-axial direction are defined as second to tenth planes, cross-sectional images having a size corresponding to full thickness of the elastic layer×500 μm are acquired as first to tenth cross-sectional images such that the images are parallel to the first to tenth planes, and the center in a direction perpendicular to the thickness direction of the elastic layer matches the center of the electrophotographic member in the axial direction, the first to tenth cross-sectional images are binarized to form first to tenth binarized images, and in the first to tenth binarized images, when shapes of the fillers are approximated as ellipses, the fillers, which are approximately ellipses and have a major axis length/minor axis length value of 2.0 or more, have an average orientation angle θ_{Ave} of 0° to 45° relative to the thickness direction of the elastic layer.

The electrophotographic member of the present disclosure contains a filler A and a filler B. Hereinafter, a mechanism by which the thermal conductivity and durability of the elastic layer are improved by a combination of a filler A having a small particle diameter and a large aspect ratio and a filler B having a large particle diameter and a small aspect ratio and the form of fillers present within the elastic layer will be described.

First, in consideration of thermal conductivity, it is necessary for fillers having a high aspect ratio to be contained and to have a distribution of larger and smaller filler particle diameters. When fillers having a high aspect ratio are used, heat is efficiently transferred in the orientation direction of the fillers, and the thermal conductivity in the thickness direction can be increased without excessively increasing the total amount of fillers. In addition, when the filler particle diameter distribution spans both large and small diameters, the gaps between the large-diameter fillers are filled with the small-diameter fillers to form a heat conduction path, and the thermal conductivity of the elastic layer in the thickness direction is excellent.

Therefore, when the filler content, V_{A} and V_{B} are set to equal to or larger than the lower limit, the aspect ratio of the filler A is set to 3.0 or more, and the average value θ_{Ave} of the orientation angle is set to be within the above range, the thermal conductivity becomes favorable.

Next, in consideration of durability, when a large stress is applied to the elastic layer, in order to prevent a rubber from breaking due to a large stress applied to the rubber matrix, it is necessary to have a distribution of larger and smaller filler particle diameters and to reduce combinations of adjacent fillers where stress is likely to concentrate.

When the filler particle diameter distribution spans both large and small diameters, a uniform dispersion state in which small-diameter particles enter the gaps between large-diameter particles is easily formed, and even when a large strain is applied to the elastic layer, the stress is dispersed throughout the matrix, the occurrence of cracks can be minimized, and thus excellent durability is achieved.

In addition, when a large stress is applied to the area where fillers are close to each other, microcracks occur. Once a microcrack occurs, stress becomes concentrated at the micro-cracked part, the crack propagates as it connects with other adjacent microcracks, and the elastic layer eventually breaks. Therefore, because the occurrence of many microcracks within the elastic layer leads to reduced durability, it is necessary to select a combination of fillers that can reduce the frequency of microcrack occurrence in order to improve durability.

Regarding stress concentration that causes microcracks, as the particle diameter of the filler becomes larger, the deformation of the matrix becomes further restricted, resulting in larger stress concentration, and the stress concentration is larger when fillers have a smaller curvature of filler tips that are close to each other. Therefore, the combination of adjacent fillers that causes the largest stress concentration is a combination of large-diameter and high-aspect-ratio fillers, and the next largest stress concentration occurs in a combination of large-diameter and high-aspect-ratio fillers and small-diameter and high-aspect-ratio fillers.

Therefore, it is thought that the frequency of microcrack occurrence can be significantly reduced by controlling the amount of fillers so that it is not excessive, using low-aspect-ratio fillers as large-diameter fillers, and controlling the aspect ratio of small-diameter fillers so that it is not too high. Therefore, in consideration of durability, it is important to set the filler content, V_{A} and V_{B} to be equal to or lower than the upper limit, and to control the aspect ratios of the filler A and the filler B.

As described above, by combining large-diameter and low-aspect-ratio fillers and small-diameter and high-aspect-ratio fillers, controlling the contents of these fillers, and additionally controlling the orientation of the high-aspect-ratio fillers, it is possible to obtain an electrophotographic member having thermal conductivity and durability.

The requirements will be described below.

The elastic layer contains fillers. The filler can be added to control, for example, the thermal conductivity, heat resistance and elastic modulus. The content of the fillers in the elastic layer is 15 to 50 volume %. When the filler content is 15 volume % or more, the elastic layer can have high thermal conductivity and favorable fixability. When the filler content is 50 volume % or less, a sufficient distance between the fillers can be maintained. Therefore, when a large stress is applied to the elastic layer, the occurrence of microcracks in the elastic layer due to stress concentration between adjacent fillers can be minimized, and excellent durability is achieved.

The content of the fillers in the elastic layer is preferably 25 to 45 volume %, more preferably 27 to 40 volume %, and still more preferably 28 to 35 volume %.

Among the fillers, one having a particle diameter of 3 μm or more and less than 10 μm is defined as a filler A, and one having a particle diameter of 10 to 40 μm is defined as filler B.

In this case, the content V_{A} of the filler A in the elastic layer is 7 to 30 volume %, and the average aspect ratio of the filler A is 3.0 to 40.0. In addition, the content V_{B} of the filler B in the elastic layer is 7 to 30 volume %, and the average aspect ratio of the filler B is 1.0 to 2.0.

When V_{A} is 7 volume % or more, excellent thermal conductivity is achieved, and when V_{A} is 30 volume % or less, excellent durability is achieved. In addition, when the average aspect ratio of the filler A is 3.0 or more, the thermal conductivity in the thickness direction can be increased without excessively increasing the total amount of fillers. When the average aspect ratio of the filler A is 40.0 or less, excellent durability is achieved.

When V_{B} is 7 volume % or more, excellent thermal conductivity is achieved, and when V_{B} is 30 volume % or less, excellent durability is achieved. In addition, when the average aspect ratio of the filler B is 2.0 or less, excellent durability is achieved.

In order to further improve thermal conductivity and durability, V_{A} is preferably 12 to 25 volume %, and more preferably 13 to 20 volume %. The average aspect ratio of the filler A is preferably 5.0 to 40.0, more preferably 7.0 to 12.0, and still more preferably 8.0 to 10.0. V_{B} is preferably 12 to 25 volume %, and more preferably 13 to 20 volume %. The average aspect ratio of the filler B is preferably 1.0 to 1.7, and more preferably 1.2 to 1.6.

In order to further improve thermal conductivity and durability, the filler A preferably includes a flat-plate-shaped filler and is more preferably a flat-plate-shaped filler. The filler B preferably includes a spherical or approximately spherical filler having an aspect ratio of 1.0 to 2.0.

100 fillers are observed using a field emission scanning electron microscope (FE-SEM), and V_{A+B} is the value obtained by dividing the sum of the volume V_{f} of the filler A and the volume V_{f} of the filler B by the sum V of the volumes V_{f} of all fillers. V_{A+B} is the total proportion of the filler A and the filler B among the fillers contained in the elastic layer.

V_{A+B} is, for example, 0.80 or more, preferably 0.90 or more, more preferably 0.95 or more, and still more preferably 0.97 or more. The upper limit of V_{A+B} is not particularly limited. V_{A+B} is, for example, 0.80 to 1.00, preferably 0.90 to 1.00, more preferably 0.95 to 1.00, and still more preferably 0.97 to 0.99.

The value of V_{A}/V_{B} is, for example, 0.4 to 3.0, preferably 0.5 to 2.0, more preferably 0.6 to 1.5, and still more preferably 0.8 to 1.3. Within the above range, it is easier to achieve thermal conductivity and durability.

In addition, the plane of the elastic layer in the thickness-circumferential direction is defined as a first plane, and the planes rotated from the first plane in increments of 10° toward the plane of the elastic layer in the thickness-axial direction are defined as second to tenth planes. Here, the circumferential direction is the circumferential direction of the rotating member, and the axial direction is the rotational axis direction of the rotating member.

Cross-sectional images having a size corresponding to the full thickness of the elastic layer×500 μm are acquired as first to tenth cross-sectional images such that each image is parallel to the first to tenth planes, and the center in a direction perpendicular to the thickness direction of the elastic layer matches the center of the electrophotographic member in the axial direction.

The acquired first to tenth cross-sectional images are binarized to form first to tenth binarized images, and in the first to tenth binarized images, the shapes of the fillers are approximated as ellipses.

The fillers, which are approximately ellipses and have a major axis length/minor axis length value of 2.0 or more, must have an average orientation angle θ_{Ave} of 0° to 45° relative to the thickness direction of the elastic layer. When θ_{Ave} is within the above range, the thermal conductivity in the thickness direction can be increased without excessively increasing the total amount of fillers in the elastic layer. As a result, an electrophotographic member having improved thermal conductivity in the thickness direction can be obtained without causing a decrease in durability of the elastic layer.

θ_{Ave} is preferably 0° to 40°, more preferably 0° to 30°, and still more preferably 0° to 25°. A smaller lower limit is preferable, and although it is not particularly limited, θ_{Ave} is preferably 10° to 40°, and may be 12° to 30°, or 15° to 25°.

The average orientation angle θ_{Ave} of the filler is preferably controlled, for example, by a step of applying an electric field to the elastic layer, which will be described below.

### Electrophotographic Member

An electrophotographic member according to at least one aspect of the present disclosure is, for example, a fixing member. In addition, the electrophotographic member is a rotating member. The electrophotographic member may have a roller shape or a belt shape. For example, the electrophotographic member is a fixing belt. In addition, the electrophotographic member may be an electrophotographic belt having an endless shape. The electrophotographic member includes a substrate and an elastic layer provided on the outer circumference of the substrate. The electrophotographic member may have a surface layer on the outer circumferential surface of the elastic layer. The substrate may be, for example, a base layer. As necessary, other layers may be provided between respective layers of the substrate, the elastic layer and the surface layer, and on the inner circumferential surface side of the substrate and on the outer circumferential surface side of the surface layer.

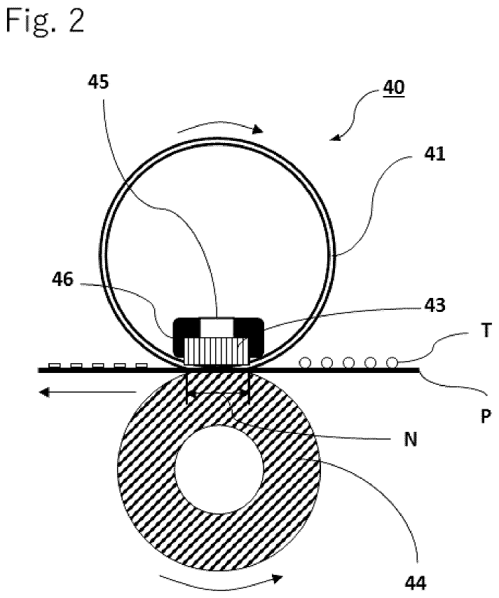

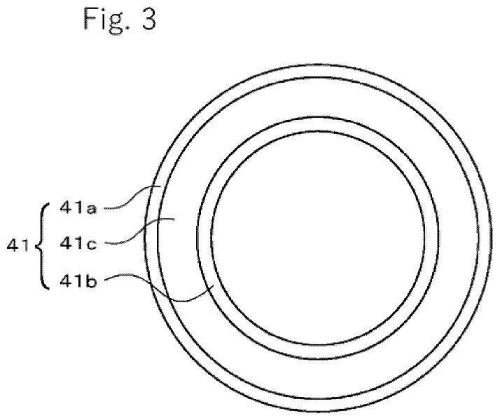

As shown in FIG. 2 and FIG. 3, a fixing member 41 is, for example, a fixing film 41. The fixing member 41 includes a substrate 41b and an elastic layer 41c. The fixing member 41 may have a surface layer 41a on the outer circumferential surface of the elastic layer 41c. The surface layer 41a can serve as a release layer having releasability with respect to, for example, toner. The surface layer 41a can form the outer surface of the electrophotographic member. Here, the surface layer 41a may be adhered to the surface of the elastic layer 41c via an adhesive layer (not shown). In addition, the substrate 41b may have an inner sliding layer (not shown) on the inner circumferential surface side.

The layers will be described below in detail.

### Substrate

The material of the substrate 41b is not particularly limited, and any known electrophotographic member may be used. For example, metals such as aluminum, iron, stainless steel (SUS), and nickel and alloys, as well as heat-resistant resins such as polyimide are used. Stainless steel is preferable. The thickness of the substrate 41b is not particularly limited, and in consideration of, for example, strength, flexibility, and heat capacity, the thickness is preferably from 20 μm to 100 μm and more preferably from 20 μm to 50 μm.

The outer surface of the substrate 41b may be subjected to a surface treatment in order to impart adhesion to the elastic layer 41c. For the surface treatment, it is possible to use one type or a combination of two or more types selected from among physical treatments such as a blasting treatment, a lapping treatment, and polishing, and chemical treatments such as an oxidation treatment, a coupling agent treatment, and a primer treatment.

When the elastic layer 41c containing a silicone rubber is provided on the surface of the substrate 41b, it is preferable to perform a primer treatment on the surface of the substrate 41b in order to improve the adhesion between the substrate 41b and the elastic layer 41c. The primer used in the primer treatment may be, for example, a paint in which a silane coupling agent, a silicone polymer, a hydrogenated methylsiloxane, an alkoxysilane, a reaction accelerating catalyst, and a colorant such as red iron oxide are appropriately added and dispersed in an organic solvent.

The primer can be appropriately selected depending on the material of the substrate 41b, the type of the elastic layer 41c or the form of the crosslinking reaction. In particular, when the elastic layer 41c contains a large amount of unsaturated aliphatic groups, a primer containing hydrosilyl groups is preferably used in order to impart adhesion by reacting with unsaturated aliphatic groups. When the elastic layer 41c contains a large amount of hydrosilyl groups, a primer containing unsaturated aliphatic groups is preferably used.

Other examples of primers include those containing alkoxy groups. Commercially available primers can be used. In addition, the primer treatment includes a step of applying the primer to the outer surface of the substrate 41b (surface to be adhered to the elastic layer 41c), and drying or firing it.

### Inner Sliding Layer

An inner sliding layer may be provided on the inner circumferential surface side of the substrate 41b. For the inner sliding layer, a resin having high durability and high heat resistance such as a polyimide resin is suitable. Since the inner sliding layer is gradually worn by rubbing, it is preferable that the layer have a thickness that enables it to sufficiently function as a sliding layer over duration of use. On the other hand, a thickness that does not interfere with supply of heat from a heater is preferable. Therefore, the thickness is preferably 5 to 20 μm and more preferably 10 to 15 μm. The inner sliding layer may be formed using a known coating method.

### Elastic Layer

The elastic layer 41c is a layer for imparting flexibility to the electrophotographic member in order to secure the fixing nip in the fixing device. Here, when the electrophotographic member is used as a heating member that comes into contact with toner on paper, the elastic layer 41c also functions as a layer that imparts flexibility so that the surface of the heating member can conform to the unevenness of the paper.

The elastic layer 41c contains a rubber and fillers dispersed in the rubber. In the elastic layer, the rubber is, for example, a matrix. More specifically, the elastic layer 41c contains a rubber and fillers dispersed in the rubber, and is formed of a cured product obtained by curing a mixture containing at least rubber raw materials (a base polymer, a crosslinking agent, etc.) and fillers.

The elastic modulus of the elastic layer 41c is preferably 0.60 to 2.00 MPa, more preferably 0.65 to 1.20 MPa, and still more preferably 0.70 to 0.90 MPa. When the elastic modulus is 0.60 MPa or more, better durability is achieved, and when the elastic modulus is 2.00 MPa or less, flexibility can be imparted.

The elastic modulus of the elastic layer 41c can be controlled by the volume fraction of the fillers in the elastic layer. In addition, the elastic modulus of the elastic layer 41c can also be changed by the amount of the crosslinking agent contained in the rubber raw material.

In addition, the thickness of the elastic layer can be appropriately designed in consideration of the surface hardness of the electrophotographic member and the width of the nip part to be formed. The thickness of the elastic layer 41c is preferably 150 to 500 μm, more preferably 200 to 400 μm, and still more preferably 200 to 300 μm.

In consideration of favorable fixability, the thermal conductivity of the elastic layer in the thickness direction is preferably 1.25 W/(m·K) or more. The thermal conductivity is more preferably 1.40 W/(m·K) or more. A higher thermal conductivity of the elastic layer in the thickness direction is preferable, and the upper limit is not particularly limited, and for example, 1.25 to 2.50 W/(m·K), 1.40 to 2.00 W/(m·K).

The elastic layer 41c preferably contains a silicone rubber having excellent heat resistance. That is, the rubber in the elastic layer is preferably a silicone rubber. In addition, as the raw material of the silicone rubber, an addition-curing liquid silicone rubber is preferably used. The elastic layer 41c can be formed, for example, by applying an addition-curing liquid silicone rubber mixture to the outer surface of the substrate 41b, and performing heating and curing. The coating method is not particularly limited, and known methods may be used.

Since the silicone rubber mixture is often a liquid, fillers disperse easily, and it is easy to adjust the elasticity of the elastic layer to be prepared by adjusting the degree of crosslinking according to the type and amount of fillers added. For this reason, the silicone rubber mixture is preferable.

The matrix has a function of exhibiting elasticity in the elastic layer. The matrix preferably contains a silicone rubber in order to exhibit the function of the elastic layer. The silicone rubber is preferable because it has high heat resistance, enabling it to maintain flexibility even in an environment where the non-sheet-passing area reaches a high temperature of about 240° C. As the silicone rubber, for example, a cured product of an addition-curing liquid silicone rubber to be described below can be used.

The liquid silicone rubber mixture generally contains the following components (a) to (d).
Component (a): organopolysiloxane having an unsaturated aliphatic group;
Component (b): organopolysiloxane containing silicon-bonded active hydrogen;
Component (c): catalyst;
Component (d): filler

Hereinafter, the components will be described.

### Component (a): Organopolysiloxane Having an Unsaturated Aliphatic Group

The organopolysiloxane having an unsaturated aliphatic group is an organopolysiloxane having an unsaturated aliphatic group such as a vinyl group, and for example, at least one selected from the group consisting of a compound represented by following Formula (1) and a compound represented by Formula (2). The organopolysiloxane having an unsaturated aliphatic group is preferably linear.

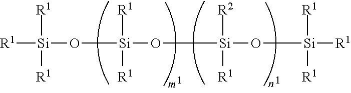

In Formula (1), m¹ is an integer of 0 or more (preferably 500 to 1,100), and n¹ is an integer of 3 or more (preferably 10 to 40). In addition, in Structural Formula (1), R¹s are each independently a monovalent unsubstituted or substituted hydrocarbon group having no unsaturated aliphatic group, provided that at least one R¹ is a methyl group, and R²s are each independently an unsaturated aliphatic group.

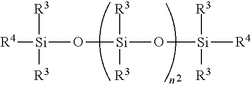

In Formula (2), n² is a positive integer (preferably 500 to 1,100), R³s are each independently a monovalent unsubstituted or substituted hydrocarbon group having no unsaturated aliphatic group, provided that at least one R³ is a methyl group, and R⁴s are each independently an unsaturated aliphatic group.

In Formula (1) and Formula (2), examples of monovalent unsubstituted or substituted hydrocarbon groups having no unsaturated aliphatic group that can be represented by R¹ and R³ include the following groups.

### Unsubstituted Hydrocarbon Group

alkyl group (for example, methyl group, ethyl group, propyl group, butyl group, pentyl group, hexyl group).
aryl group (for example, phenyl group).

### Substituted Hydrocarbon Group

substituted alkyl group (for example, chloromethyl group, 3-chloropropyl group, 3,3,3-trifluoropropyl group, 3-cyanopropyl group, 3-methoxypropyl group).

The organopolysiloxanes represented by Formulae (1) and (2) have at least one methyl group directly bonded to a silicon atom forming a chain structure. However, for ease of synthesis and handling, it is preferable that 50% or more of each of R¹ and R³ be methyl groups, and it is more preferable that all of R¹ and R³ be methyl groups.

In addition, examples of unsaturated aliphatic groups that can be represented by R² and R⁴ in Formulae (1) and (2) include the following groups. That is, examples of unsaturated aliphatic groups include a vinyl group, an allyl group, a 3-butenyl group, a 4-pentenyl group, and a 5-hexenyl group. Among these groups, it is preferable that both R² and R⁴ be vinyl groups because they are easy to synthesize and handle and inexpensive, and they readily undergo a crosslinking reaction.

In consideration of moldability, the viscosity of the component (a) is preferably from 1,000 mm²/s to 50,000 mm²/s, more preferably from 1,000 mm²/s to 20,000 mm²/s, and still more preferably from 3,000 mm²/s to 8,000 mm²/s. When the viscosity is 1,000 mm²/s or more, it becomes easy to adjust the hardness required for the elastic layer, and when the viscosity is 50,000 mm²/s or less, application becomes easy. The viscosity (kinematic viscosity) can be measured using a capillary viscosimeter or a rotational viscometer based on JIS Z 8803:2011.

The amount of the component (a) added based on the liquid silicone rubber mixture used to form the elastic layer is preferably 50 volume % or more in consideration of durability and 85 volume % or less in consideration of heat transfer, and more preferably 60 volume % or more in consideration of durability, and 80 volume % or less in consideration of heat transfer.

### Component (b): Organopolysiloxane Containing Silicon-Bonded Active Hydrogen

The organopolysiloxane containing silicon-bonded active hydrogen functions as a crosslinking agent that reacts with the unsaturated aliphatic group of the component (a) under the action of a catalyst to form a cured silicone rubber.

As the component (b), any organopolysiloxane having a Si—H bond can be used. In particular, in consideration of the reactivity with the unsaturated aliphatic group of the component (a), those having an average of three or more hydrogen atoms bonded to silicon atoms per molecule are preferably used.

Specific examples of components (b) include a linear organopolysiloxane represented by following Formula (3) and a cyclic organopolysiloxane represented by following Formula (4).

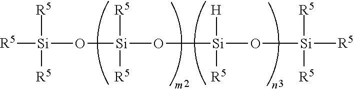

In Formula (3), m² is an integer of 0 or more (preferably 10 to 30), n³ is an integer of 3 or more (preferably 5 to 20), and R's are each independently a monovalent unsubstituted or substituted hydrocarbon group having no unsaturated aliphatic group.

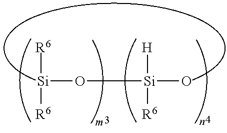

In Formula (4), m³ is an integer of 0 or more (preferably 10 to 30), n⁴ is an integer of 3 or more (preferably 5 to 20), and R⁶s are each independently a monovalent unsubstituted or substituted hydrocarbon group having no unsaturated aliphatic group.

Examples of monovalent unsubstituted or substituted hydrocarbon groups having no unsaturated aliphatic group that can be represented by R⁵ and R⁶ in Formula (3) and Formula (4) include the same groups as those for R¹ in Formula (1). Among these, it is preferable that 50% or more of each of R⁵ and R⁶ be methyl groups, and it is more preferable that all of R⁵ and R⁶ be methyl groups because synthesis and handling are easy and excellent heat resistance is easily obtained.

### Component (c): Catalyst

The catalyst used to form a silicone rubber is, for example, a hydrosilylation catalyst for accelerating a curing reaction. As the hydrosilylation catalyst, for example, known substances such as a platinum compound and a rhodium compound can be used. The amount of the catalyst added can be appropriately set and is not particularly limited.

### Component (d): Filler

As described above, the elastic layer contains fillers.

The filler material is selected in consideration of its own thermal conductivity, specific heat capacity, density, particle diameter, dielectric constant, and the like. Examples of fillers used to improve heat transfer properties of inorganic materials, in particular, metals, and metal compounds, include the following: silicon carbide, silicon nitride, boron nitride, aluminum nitride, alumina, zinc oxide, magnesium oxide, silica, copper, aluminum, silver, iron, nickel, metal silicon, carbon fibers.

In addition, in consideration of the thermal conductivity, electrical resistance value, and dielectric constant of the filler itself, the fillers A and B are more preferably at least one filler selected from the group consisting of alumina, zinc oxide, metal silicon, silicon carbide, boron nitride and magnesium oxide.

The filler A preferably contains at least one selected from the group consisting of metal silicon and boron nitride, and more preferably contains boron nitride. In particular, the filler A preferably contains flat-plate-shaped boron nitride.

The filler A preferably has a 10% particle diameter (D10) of 3.0 to 6.0 μm based on volume distribution.

The filler A preferably has a 50% particle diameter (D50) of 4.0 to 8.0 μm based on volume distribution.

The filler A preferably has a 90% particle diameter (D90) of 5.0 to 9.0 μm based on volume distribution.

The filler B may contain, for example, alumina particles.

The filler B preferably has a 10% particle diameter (D10) of 10.0 to 18.0 μm based on volume distribution.

The filler B preferably has a 50% particle diameter (D50) of 10.0 to 20.0 μm based on volume distribution.

The filler B preferably has a 90% particle diameter (D90) of 10.0 to 25.0 μm based on volume distribution.

Hereinafter, as one embodiment, a corona charging device 2 and a step of applying an electric field to the elastic layer using the device will be described. Corona charging methods include a scorotron method in which a grid electrode is provided between a corona wire and a component to be charged, and a corotron method in which no grid electrode is provided, and the scorotron method is preferable in consideration of controllability of the surface potential of the component to be charged.

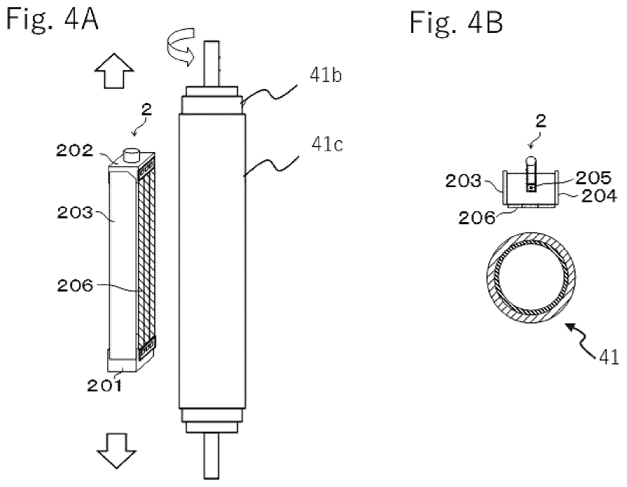

As shown in FIG. 4A and FIG. 4B, the corona charging device 2 includes a front block 201, a rear block 202, and shields 203 and 204. In addition, a discharge wire 205 is stretched between the front block 201 and the rear block 202, and when a charging bias is applied from a high-voltage power source, discharging is performed and the surface of the uncured elastic layer 41c on the substrate as a component to be charged is charged.

Similar to the configuration of a general corona charging device, a high voltage is applied to the discharge wire 205 as a discharging member. Then, an ion current obtained by discharging to the shields 203 and 204 is controlled by applying a high voltage to a grid 206, and the surface of the elastic layer 41c is controlled such that it has a desired charge potential. In this case, since the substrate 41b or the core 1 holding the substrate 41b is grounded (not shown), it is possible to generate a desired electric field in the elastic layer 41c by controlling the surface potential of the surface of the elastic layer 41c.

To describe in detail the method of producing the fixing member according to the above embodiment, first, an elastic layer containing a silicone rubber containing fillers is formed on a substrate. Next, as shown in FIG. 4A, the corona charging device 2 is disposed so that it approaches and faces in the width direction of the uncured elastic layer 41c of the fixing member 41. Then, a voltage is applied to the grid 206 of the corona charging device 2, and in a discharged state, for example, the fixing member 41 is rotated at 141 rpm for 160 seconds, and thus the surface of the elastic layer is charged. The distance between the surface of the elastic layer and the grid 206 can be 1 mm to 10 mm. The surface of the elastic layer 41c is charged in this manner, an electric field is generated within the elastic layer, and thermally conductive fillers are oriented. Then, the elastic layer is cured by heating or the like, and the orientation of the fillers is fixed.

The voltage applied to the grid 206 is preferably in the absolute value range of 0.1 kV to 3 kV (0.2 to 6 kV in Vp-p in the case of AC application) in order to generate an effective electrostatic interaction in the filler. When an electric field is used to orient the fillers in the thickness direction of the elastic layer, it is important to generate an electrical field in the thickness direction of the elastic layer 41c. If the sign of the applied voltage is the same as the sign of the voltage applied to the wire, the obtained effect is the same, even though the direction of the electrical field is opposite whether it is negative or positive.

In addition, when AC charging is performed in order to curb a liquid surface flow to be described below, it is desirable to match the waveform phases of the wire and the grid. Depending on the type and content of the fillers, it may be difficult to orient the fillers, and in this case, it is desirable to increase the voltage applied to the grid 206. This is speculated to be related to the dielectric constants of the silicone rubber component and the thermally conductive filler. When the difference in dielectric constant between the silicone rubber and the filler is large, or when the content is small, it is possible to orient the fillers with a relatively low applied voltage.

On the other hand, when the voltage applied to the grid 206 is too large, the electrostatic repulsion force due to the surface charge of the elastic layer increases, a liquid surface flow is caused, and surface properties of the elastic layer 41c may deteriorate. Therefore, the voltage applied to the grid 206 is more preferably in the absolute value range of 0.1 kV to 1.5 kV (0.2 to 3 kV in Vp-p in the case of AC application). This liquid surface flow can be alleviated by AC charging.

As a configuration for controlling the potential on the surface of the elastic layer in the longitudinal direction, for example, the configuration shown in FIG. 4A can be used, and while a voltage is applied to the grid 206, the entire elastic layer 41c can be charged by rotating the fixing member 41 around its central axis. Here, it is preferable to set the rotation speed of the fixing member to be 10 rpm to 500 rpm and set the treatment time to be 20 seconds or longer in order to stably orient the fillers. As described above, when the value of the voltage applied to the grid and the time for which an electric field is applied are controlled, it is possible to control the average orientation angle θ_{Ave} of the fillers.

The discharge wire 205 may be made of stainless steel, nickel, molybdenum, tungsten or the like, but it is preferable to use tungsten, which is an extremely highly stable metal. Here, the discharge wire stretched inside the shield may have a circular cross-sectional shape or a saw tooth shape.

In addition, the diameter of the discharge wire 205 is preferably 40 μm to 100 μm. This is because, when the diameter of the discharge wire is within the above range, it is possible to prevent the discharge wire from being cut by ions during discharge, and it also eliminates the need to apply an excessively high voltage to generate a corona discharge. As the voltage applied to the discharge wire 205, either a DC voltage or an AC voltage can be used. In the case of AC voltage, a frequency of about 0.01 Hz to 1,000 Hz is preferably used. The voltage can be applied by outputting a square wave, a sine wave or the like using an arbitrary waveform generator.

### Surface Layer

The electrophotographic member may have the surface layer 41a on the outer circumferential surface of the elastic layer 41c. The surface layer 41a can be made of a fluororesin material with a thickness of 100 μm or less, preferably 10 to 70 μm. For example, fluorine resin layers contain, for example, PTFE, FEP, and PFA, and in consideration of releasability and rigidity, PFA is preferable. PFA is a copolymer of perfluoroalkyl vinyl ether (PAVE) and tetrafluoroethylene (TFE).

Examples of methods of forming the surface layer 41a containing PFA include a method in which a dispersion solution (water-based dispersion paint) or powder paint containing PFA as a main component is applied to the surface of the elastic layer 41c and heated to a melting point or higher to form a film. Alternatively, a method of covering the surface of the elastic layer 41c with a PFA tube produced by separate extrusion molding may be exemplified. The surface layer 41a is, for example, a PFA tube.

As PFA, commercially available one can be used. Specific examples thereof include AP-230 (product name, commercially available from Daikin Industries, Ltd.), AP-231SH (product name, commercially available from Daikin Industries, Ltd.) which is a PFA with completely fluorinated end groups, and 451HP-J (product name, commercially available from Chemours-Mitsui Fluoroproducts Co., Ltd.) which has a small spherulite size.

The inner surface of the surface layer 41a is subjected to a sodium treatment, an excimer laser treatment, an ammonia treatment, or a plasma etching treatment in advance, and thus the adhesion can be improved. In this example, a PFA tube with a thickness of 20 μm obtained by extrusion molding is used.

### Adhesive Layer

The surface layer 41a may be adhered to the surface of the elastic layer 41c with an adhesive layer (not shown) therebetween. When the adhesive layer is provided, it is easier to adhere the elastic layer and the surface layer. The material of the adhesive layer is not particularly limited, and known materials can be used. For example, the adhesive layer preferably contains a cured adhesive product. The adhesive may be a solution type adhesive or a hot melt type adhesive.

The adhesive is not particularly limited, and known adhesives can be used, and a silicone rubber adhesive is preferably used.

The thickness of the adhesive layer is not particularly limited, and is preferably 1 to 20 μm, and more preferably 3 to 10 μm.

### Electrophotographic Image Forming Apparatus

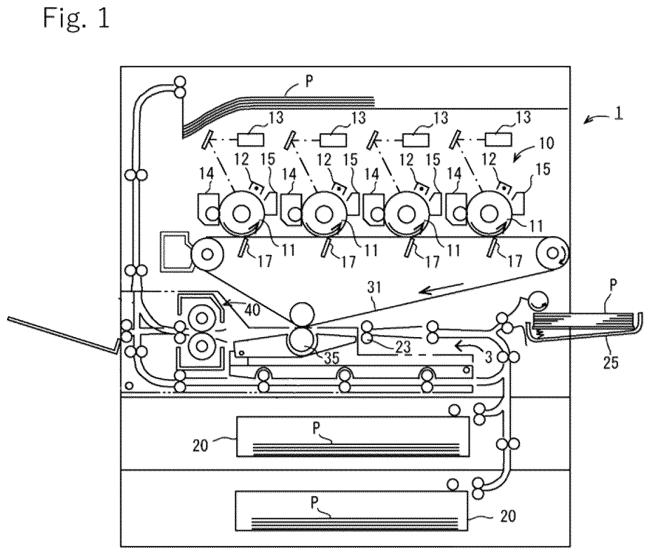

FIG. 1 is a cross-sectional view of a color electrophotographic printer which is an example of an electrophotographic image forming apparatus (hereinafter referred to as an “image forming apparatus”) of the present embodiment, and is a cross-sectional view of the recording material in the transport direction. In the present embodiment, the color electrophotographic printer is simply referred to as a “printer.”

A printer 1 shown in FIG. 1 includes image forming units 10 for colors Y (yellow), M (magenta), C (cyan), and Bk (black). A photosensitive drum (photosensitive member) 11 is charged in advance by a charging device 12. Then, the photosensitive drum 11 is exposed to light by a laser scanner 13, and an electrostatic latent image is formed. The electrostatic latent image is developed into a toner image by a developing device 14. The toner image on the photosensitive drum 11 is sequentially transferred by a primary transfer blade 17 to an image bearing member, for example, an intermediate transfer belt 31. After the transfer, the toner remaining on the photosensitive drum 11 is removed by a cleaner 15. As a result, the surface of the photosensitive drum 11 is cleaned and prepared for the next image formation.

On the other hand, a recording material P is sent one by one in the direction of an arrow 3 from a paper feeding cassette 20 or a multi-feed tray 25 to a pair of registration rollers 23. The pair of registration rollers 23 first receive the recording material P, and straighten the recording material if it is skewed. Then, the pair of registration rollers 23, in synchronization with the toner image on the intermediate transfer belt 31, send the recording material P between the intermediate transfer belt 31 and a secondary transfer roller 35. The color toner image on the intermediate transfer belt is transferred to the recording material P by a transfer member, for example, the secondary transfer roller 35. Then, the toner image on the recording material P is fixed to the recording material when the recording material P is heated and pressed by a fixing device 40.

The electrophotographic image forming apparatus includes the fixing device 40. Next, the fixing device in the electrophotographic image forming apparatus will be described. The fixing device includes a fixing member and a pressure member disposed opposite to the fixing member. FIG. 2 is a schematic configuration diagram of the fixing device 40, which is an example of a film heating type heating device (tensionless type). In this example, such a heating device is used, but a roller-pair type or film-type heating device can also be used.

Reference numeral 43 indicates a ceramic heater (hereinafter referred to as a heater) as a heating member. The heater 43 has a basic configuration including an elongated thin ceramic substrate whose longitudinal direction is perpendicular to the plane of the drawing and a current-applying heat-generating resistive layer provided on the surface of the substrate. The heater 43 is a low-heat-capacity heater that is heated with a steep rise characteristic across its entire surface when a current is applied to the heat-generating resistive layer. In addition, the heater is configured to switch the current-applied area according to the longitudinal width size of the recording material.

The electrophotographic member according to at least one aspect of the present disclosure can be used as, for example, a fixing member. The fixing film 41 is a cylindrical (endless) heat-resistant fixing member as a heating member that transmits heat and is loosely fitted onto a support member (heater holder) including the heater 43. The fixing film 41 has a structure shown in FIG. 3, which is a fixing film having a three-layer composite structure including at least the surface layer 41a, the elastic layer 41c, and the substrate 41b.

A pressure roller 44 is a heat-resistant elastic pressure roller as a pressure member, and has a core and an elastic layer made of a heat-resistant rubber such as a silicone rubber or a fluorine rubber, or a silicone rubber foam. Both ends of the core are arranged so that they are rotatably supported by bearings. Here, the electrophotographic member according to at least one aspect of the present disclosure can also be used as, for example, a pressure member. That is, at least one of the fixing member and the pressure member is preferably the electrophotographic member. For example, the pressure member can have the same configuration as the fixing film 41, and the pressure member can have a three-layer composite structure including the surface layer 41a, the elastic layer 41c, and the substrate 41b.

The fixing film 41 and the heater 43 are disposed above the pressure roller 44 in parallel with the pressure roller 44, and pressed by a pressing member (not shown). In this manner, the lower surface of the heater 43 and the upper surface of the pressure roller 44 are pressed against each other with the fixing film 41 therebetween, against the elasticity of the elastic layer, and a fixing nip part N with a predetermined width as a heating part can be formed.

The pressure roller 44 is driven to rotate by a driving means (not shown) at a predetermined rotation circumferential speed in the counterclockwise direction indicated by the arrow. The pressure roller 44 is driven to rotate, and a rotational force is applied to the cylindrical fixing film 41 due to a pressure friction force at the fixing nip part N between the pressure roller 44 and the fixing film 41. Then, the fixing film 41 comes in contact with the downward surface of the heater 43 and slides thereon, and is driven to rotate in the clockwise direction indicated by the arrow. A support member (heater holder) 46 is a rotation guide member for the cylindrical fixing film 41.

The pressure roller 44 is driven to rotate, the cylindrical fixing film 41 is driven to rotate accordingly, a current is applied to the heater 43, and the heater is quickly heated to reach a predetermined temperature, and is brought into a temperature-regulated state. In this state, the recording material P carrying the unfixed toner image T is introduced into the fixing nip part N between the fixing film 41 and the pressure roller 44. Then, in the fixing nip part N, the toner-image carrying side of the recording material P comes into close contact with the outer surface of the fixing film 41 and is nipped and transported through the fixing nip part N together with the fixing film 41. During this nipping and transporting process, the recording material P is heated by heat from the fixing film 41 that has been heated by the heater 43, and the unfixed toner image T on the recording material P is heated and pressed onto the recording material P and melted and fixed. The recording material P that has passed through the fixing nip part N is curvature-separated from the surface of the fixing film 41 and discharged and transported.

The maximum surface pressure of the recording material in the fixing nip part N in the transport direction is preferably 0.25 to 0.40 MPa and more preferably 0.35 to 0.40 MPa. When the surface pressure in the fixing nip part is increased, the amount of toner deformation can be increased and the image quality can be increased.

The pressure applied to the fixing nip part N is measured using a tactile sensor (commercially available from Nitta Corporation). In measurement conditions, measurement is performed at 0.5 mm intervals in the transport direction, and at 2 mm intervals in the direction perpendicular to the transport direction. The maximum surface pressure in the transport direction of the recording material in the fixing nip part N is the maximum value in the pressure distribution in the transport direction passing through the center A in the sheet-passing area of the nip part N. Here, the center A is the center of the sheet-passing area of the nip part N in the longitudinal direction. The sheet-passing area of the nip part N is an area of the nip part N through which the recording material fixed by the fixing device 40 can pass.

Reference numeral 45 indicates a contact type thermometer (thermistor) that measures the temperature of the fixing film 41 heated by the heater 43 and transmits the detection result to a temperature control unit (not shown). Reference numeral 46 indicates a heater holder, and is a member that holds the heater 43 heated to a high temperature.

The methods of measuring physical properties in the present disclosure are described below.

### Measurement of Thermal Conductivity of Elastic Layer in Thickness Direction

The thermal conductivity 2 of the elastic layer in the thickness direction is calculated by the following formula.

$$λ = α \times {C}_{p} \times ρ$$

In the formula, λ is the thermal conductivity (W/(m·K)) of the elastic layer in the thickness direction, α is the thermal diffusivity in the thickness direction (m²/s), Cₚ is the specific heat at constant pressure (J/(kg·K)), ρ is the density (kg/m³). Here, the values of the thermal diffusivity α in the thickness direction, the specific heat at constant pressure Cₚ, and the density ρ are determined by the following methods.

### Thermal Diffusivity α

The thermal diffusivity α of the elastic layer in the thickness direction is measured using a periodic heating method thermal property measurement device (product name: FTC-1, commercially available from Advance Riko., Inc.) at room temperature (25° C.). A total of five sample pieces, each having an area of 8×12 mm, cut out from the elastic layer using a cutter, are prepared, and the thickness of each sample piece is measured using a digital length measuring system (product name: DIGIMICRO MF-501, flat measuring tip φ 4 mm, commercially available from Nikon Corporation). Next, each sample piece is measured a total of five times, and the average value (m²/s) is determined. Here, the measurement is performed while applying pressure to the sample piece using a 1 kg weight.

### Specific Heat at Constant Pressure Cₚ

The specific heat at constant pressure of the elastic layer is measured using a differential scanning calorimeter (product name: Q2000, commercially available from TA Instruments).

Specifically, an aluminum pan is used as a sample pan and a reference pan. First, for blank measurement, measurement is performed using a program in which both pans are empty, the temperature is kept constant at 15° C. for 10 minutes, then raised to 215° C. at a ramp rate of 10° C./min, and the temperature is additionally kept constant at 215° C. for 10 minutes.

Next, 10 mg of synthetic sapphire with a known specific heat at constant pressure is used as a reference substance, and measurement is performed using the same program. Next, a 10 mg measurement sample, which has the same amount as the synthetic sapphire of the reference substance, is cut out from the elastic layer and then set in a sample pan, and measurement is performed using the same program. These measurement results are analyzed using specific heat analysis software bundled in the differential scanning calorimeter, and the specific heat at constant pressure Cₚ at 25° C. is calculated from the average value of five measurement results.

### Density ρ

The density of the elastic layer is measured using a dry automatic density meter (product name: AccuPyc II1340, commercially available from Shimadzu Corporation).

Specifically, a 10 cm³ sample cell is used, a sample piece is cut out from the elastic layer so that it fills approximately 80% of the cell volume, and after the mass of the sample piece is measured, the sample piece is put into the sample cell. This sample cell is set in the measurement unit of the device, and after purging with nitrogen gas, the volume is measured 10 times. For each measurement, the density of the elastic layer is calculated from the mass of the sample piece and the measured volume, and the average value is obtained.

The thermal conductivity λ of the elastic layer in the thickness direction is calculated from the unit-converted specific heat at constant pressure Cₚ (J/(kg K)), the density ρ (kg/m³), and the measured thermal diffusivity α(m²/s) of the elastic layer.

### Measurement of Content of Filler

6 g of a sample is collected from the elastic layer and immersed in a silicone resin dissolving agent (product name: eSolve 21RS, commercially available from Kaneko Chemical Co., Ltd.), the silicone rubber is dissolved, and fillers are extracted. The extracted fillers are washed using toluene and dried at a temperature of 25° C. for 1 hour, and the mass of the fillers is measured. Next, the density of the fillers is measured using a dry automatic density meter (product name: AccuPyc II1340, commercially available from Shimadzu Corporation). The filler content (volume %) of the elastic layer is determined from the values of the mass and density of the fillers contained in 6 g of the elastic layer obtained in this manner.

Calculation of Content V_{A}, Content V_{B}, and Average Aspect Ratio

First, the fillers collected in the measurement of the filler content are dispersed in toluene to prepare a dispersion solution. The dispersion solution is applied onto a substrate (aluminum foil) and dried to prepare an observation sample using a field emission scanning electron microscope (FE-SEM). The condition for the concentration of the dispersion solution is adjusted so that the filler particles do not overlap and can be observed individually. Next, the observation sample is set on a 45° inclined sample table and the fillers are observed using an FE-SEM (product name: SU8220, commercially available from Hitachi High-Tech Corporation) under the following conditions.

### SEM Observation Conditions

Acceleration voltage: 2.0 kV
WD: 12 mm
Sample inclination angle: 45°,−45°

The observation magnification is appropriately adjusted depending on the size of the filler.

By performing observation under the above conditions, it is possible to observe the upper surface and the side surface of the observation sample. An observation image is obtained for each individual filler in which the entire upper surface and side surface are visible, the major axis d₁ and the minor axis d₂ are determined from the upper-surface observation image, and the thickness h is determined from the side-surface observation image.

Method of Calculating Major Axis d₁ and Minor Axis d₂

The observation image of the upper surface of the filler is subjected to binarization processing using image analysis software “ImageJ” so that the filler part appears white and the non-filler part appears black, the filler is then approximated as an ellipse, and the major axis d₁ and the minor axis d₂ are determined. Specifically, first, the user selects Analyze-Set Scale in ImageJ software, and sets the actual length per pixel using a scale bar in the SEM observation condition display unit.

Next, the user selects Image-Adjust-Threshold, and designates a brightness threshold so that only the filler part is selected. Then, the user selects Analyze-Set Measurements, checks Fit ellipse, selects Analyze-Analyze Particles, and sets the output Major value as the major axis d₁ of the filler and the Minor value as the minor axis d₂ of the filler.

### Method of Calculating Thickness h

For the observation image of the side surface of the filler, the height of the filler from the substrate surface of the observation sample is defined as the thickness h.

As described above, the major axis d₁, the minor axis d₂, and the thickness h are determined, and the volume V_{f} and particle diameter R_{f} of the fillers are calculated by the following formula. In addition, the larger value of the values obtained by dividing d₁ of each filler by d₂ or h is defined as the aspect ratio of the filler.

$$Volume {V}_{f} = 3.14 \times {d}_{1} / 2 \times {d}_{2} / 2 \times h$$

$$Particle diameter {R}_{f} = {( {V}_{f} \times 6 / 3.14 )}^{1 / 3}$$

The V_{f}, R_{f}, and aspect ratio are determined for each of 100 fillers, one having a particle diameter R_{f} of 3 μm or more and less than 10 μm is defined as a filler A, and one having a particle diameter R_{f} of 10 to 40 μm is defined as a filler B. A total volume V_{f} of the filler A, a total volume V_{f} of the filler B, and the sum V of the volumes V_{f} of all fillers are determined, and V_{A} and V_{B} are calculated by the following formulae.

$${V}_{A} = ( filler content ( volume \% ) ) \times ( total volume {V}_{f} of the filler A ) / V$$

$${V}_{B} = ( filler content ( volume \% ) ) \times ( total volume {V}_{f} of the filler B ) / V$$

In addition, the arithmetic means of the aspect ratios of the filler A and the filler B are determined, and used as the average aspect ratios of the filler A and the filler B. In addition, from the volumes V_{f} of 100 fillers, the value V_{A+B} is calculated by dividing the sum of the volume V_{f} of the filler A and the volume V_{f} of the filler B by the sum V of the volumes V_{f} of all fillers.

Calculation of Average Orientation angle θ_{Ave} of Filler

The average orientation angle θ_{Ave} of the filler is calculated by performing image analysis using a binarized image obtained from a cross-sectional image of the elastic layer. Details are as follows.

### Preparation of Cross Section for Measurement

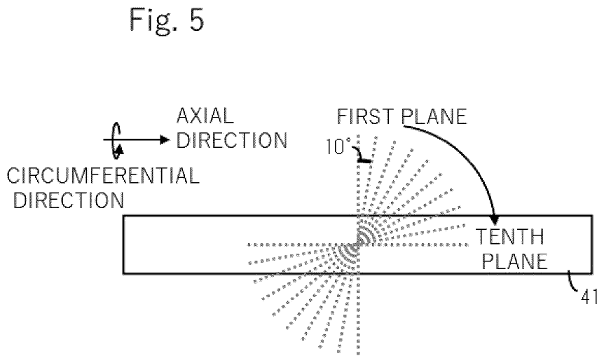

As shown in FIG. 5, the plane of the fixing member 41 as an electrophotographic member in the thickness direction-circumferential direction is defined as a first plane, and the planes rotated from the first plane in increments of 10° toward the thickness direction-axial direction of a fixing member 1 are defined as second to tenth planes.

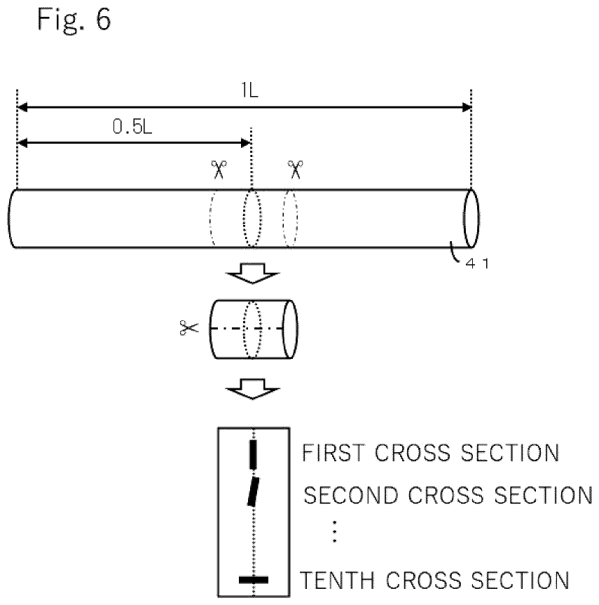

As shown in FIG. 6, the fixing member 41 is cut into round slices with a width of 500 μm or more in the axial direction to pass through the midpoint of the fixing member 41, and then cut open in the axial direction to obtain a strip-shaped sample. Then, the strip-shaped sample is divided into 10 equal areas in the circumferential direction, and cross sections with a length of 500 μm or more are cut out from each of the areas so that they are parallel to the first to tenth planes of the fixing member 1 and pass through the midpoint of the fixing member in the axial direction, and are defined as first to tenth cross sections.

When the cross section is cut out, a cross section sample piece is acquired using a sharp scissor. Then, a cross-section formation method using an ion beam is used. When a cross-section formation method using an ion beam is used, it is possible to prevent falling off of fillers and contamination from excess components such as a polishing agent, which tend to occur during cross-section polishing processing, and it is possible to form a cross section with few polishing marks. A cross-section polisher (IM4000+, commercially available from Hitachi High-Tech Corporation) is used for cross-section formation processing using an ion beam.

### Observation and Binarization of Cross-Sectional Image

Next, the obtained cross sections are observed using a laser microscope (OPTELICS H1200, commercially available from Lasertec Corporation), and after performing auto adjustment of contrast and brightness, cross-sectional images covering the entire area of the elastic layer in the thickness direction×500 μm area in the direction perpendicular to the thickness are acquired. In this case, the midpoint at 500 μm in the direction perpendicular to the thickness matches the midpoint of the fixing member in the axial direction.

The obtained images are subjected to black-and-white binarization processing using commercially available image analysis software so that the filler part appears white and the silicone rubber part appears black. “ImageJ” is used as the image analysis software, and binarization processing is performed so that the filler part appears white and the non-filler part appears black. Specifically, the user selects Analyze-Set Scale in ImageJ, and sets the actual length per pixel using a scale bar in the image. The user selects Image-Adjust-Brightness/Contrast, and presses Auto to perform auto adjustment of contrast and brightness. If the auto adjustment does not work well, adjustment is performed manually. Next, the user selects Image-Adjust-Threshold, selects “Otsu” as the thresholding method, and performs binarization. As the image to be used for analysis, an image in which only the elastic layer is shown as much as possible is selected.

### Calculation of θ_{Ave}

Each filler in the obtained 10 cross section binarized images is approximated as an ellipse, and the ellipse major axis a, the ellipse minor axis b, and the angle θ formed by the major axis of the ellipse with respect to the thickness direction of the elastic layer (referred to as a filler orientation angle) are calculated using image analysis software. Specifically, after acquiring a binarized image in ImageJ as described above, the user selects Analyze-Set Measurements, checks Fit ellipse, selects Analyze-Analyze Particles, and sets the output Major value as the major axis a of the filler, the Minor value as the minor axis b of the filler, and the Angle value as θ.

In this case, the filler orientation angle θ is defined as 0° when the long axis direction of the filler approximated as an ellipse is parallel to the thickness direction of the elastic layer, θ is defined as 90° when the long axis direction of the filler is perpendicular to the thickness direction of the elastic layer, and the value is converted so that the range of 0 is 0 to 90°. Therefore, as the filler orientation angle is closer to 0°, the filler is more strongly oriented in the thickness direction.

Using the ellipse major axis length and minor axis length calculated from 10 cross-sectional images, the value of the major axis length a/minor axis length b is calculated, and data about only fillers in which the value of the major axis length a/minor axis length b is 2.0 or more is extracted. The average value of all of the orientation angles θ of the fillers with a major axis length/minor axis length of 2.0 or more extracted from 10 cross-sectional images is defined as the average orientation angle θ_{Ave} of the filler with respect to the thickness direction of the elastic layer.

### Measurement of Thickness of Elastic Layer

The thickness of the elastic layer is calculated from the cross-sectional images of the first to tenth cross sections obtained when the average orientation angle θ_{Ave} of the filler is calculated. The arithmetic average value of 10 cross sections is used.

### Measurement of Elastic Modulus of Elastic Layer

The tensile elastic modulus is measured by the following method and used as the elastic modulus of the elastic layer.

A sample piece is cut out from the elastic layer using a punching die (dumbbell type No. 8 as specified in JIS K 6251:2004), and the thickness near the center, which is the measurement point, is measured. Next, the cut sample piece is tested using a precision universal testing machine (product name: Autograph AG-X, commercially available from Shimadzu Corporation) at a tensile speed of 200 mm/min at room temperature. Here, a graph is created from the measurement results, with the horizontal axis representing the strain of the sample piece and the vertical axis representing the tensile stress, and the tensile elastic modulus is defined as the slope obtained by linear approximation of measurement data in a strain range of 0 to 10%. The arithmetic average value of 10 sample pieces is used.

### EXAMPLES

The present disclosure will be described below in more detail with reference to examples and comparative examples, but the aspects of the present disclosure are not limited thereto.

### Classification Treatment of Filler

Spherical alumina particles (product name: DAM-10: commercially available from Denka Co., Ltd.), plate-shaped boron nitride particles (product name: GP: commercially available from Denka Co., Ltd., MGP: commercially available from Denka Co., Ltd.), and metal silicon (product name: #200WB: commercially available from Kinsei Matec Co., Ltd., Fine: commercially available from Kinsei Matec Co., Ltd.) were used as raw materials, fillers were subjected to a classification treatment or a spheroidizing treatment to obtain Fillers 1 to 10 having desired particle size distributions and aspect ratios.

The classification treatment was performed using an inertial classification type elbow jet (commercially available from Nittetsu Mining Co., Ltd.), the operation conditions were a feed rate of 5 kg/hr, and an F classification edge (fine powder classification edge) and a G classification edge (coarse powder classification edge) were adjusted so that a desired particle size distribution was obtained.

The spheroidizing treatment was performed using a multifunctional particle design device faculty (commercially available from Hosokawa Micron Corporation), and the rotation speed of the dispersion unit and the rotation speed of the classification unit were adjusted so that a desired aspect ratio and particle size distribution were obtained.

For the obtained Fillers 1 to 10, in the same method as in the calculation of the V_{A}, V_{B}, and average aspect ratio, V_{f} and R_{f} of 100 fillers were determined, and the values of the 50% particle diameter (D50), the 10% particle diameter (D10), and the 90% particle diameter (D90) based on volume distribution were calculated. Table 1 shows the raw materials of Fillers 1 to 10 and D50, D10, and D90.

### Example 1

In this example, a fixing film as shown in FIG. 3 was prepared.

### Substrate

SUS with an inner diameter of 24 mm and a thickness of 30 μm was used as a substrate. Specifically, a SUS endless belt with an inner diameter of 24 mm, a width of 400 mm, and a thickness of 30 μm was used as a substrate. Here, during a series of production steps, the endless belt with a core inserted therein was handled.

### Formation of Inner Sliding Layer

First, approximately equimolar amounts of an aromatic tetracarboxylic dianhydride or its derivative, and an aromatic diamine were reacted in an aprotic polar organic solvent to obtain a polyimide precursor solution. The obtained polyimide precursor solution was applied to the inner circumferential surface of the substrate by a ring coating method, the solvent was dried in an electric furnace, and heating was then performed at 260 to 400° C. for about 1 hour to form an inner sliding layer. The thickness of the inner sliding layer was 12 μm.

### Preparation of Silicone Rubber Mixture

A liquid addition-curing silicone rubber mixture was prepared by mixing the following components (a) to (d) by the following procedure.
Component (a): linear organopolysiloxane having an unsaturated aliphatic group
Component (b): organopolysiloxane containing silicon-bonded active hydrogen
Component (c): catalyst
Component (d): filler

First, as the component (a), 100 parts by mass of a silicone polymer having vinyl groups which are unsaturated aliphatic groups, only at both ends of the molecular chain, and having methyl groups, which are unsubstituted hydrocarbon groups containing no other unsaturated aliphatic groups, was prepared. This silicone polymer (product name: DMS-V35, commercially available from Gelest, a viscosity of 5,000 mm²/s) will hereinafter be referred to as “Vi.”

Next, 98.7 parts by mass of Filler 3 and 43.9 parts by mass of Filler 10 were added to this Vi as the component (d), and the mixture was set in a planetary centrifugal mixer (commercially available from Thinky Corporation, ARV-5000) and stirred and mixed at 600 rpm for 2 minutes to obtain Mixture 1.

Next, a solution obtained by dissolving 0.2 parts by mass of 1-ethynyl-1-cyclohexanol (commercially available from Tokyo Chemical Industry Co., Ltd.) as a curing retarder in the same weight of toluene was added to Mixture 1 to obtain Mixture 2.

Next, 0.1 parts by mass of a hydrosilylation catalyst (platinum catalyst: a mixture of 1,3-divinyltetramethyldisiloxane platinum complex, 1,3-divinyltetramethyldisiloxane, and 2-propanol) as the component (c) was added to Mixture 2 to obtain Mixture 3.

In addition, 1.3 parts by mass of a silicone polymer having a linear siloxane framework and silicon-bonded active hydrogen groups only on the side chains (product name: HMS-301, commercially available from Gelest, a viscosity of 30 mm²/s, hereinafter referred to as “SiH”) as the component (b) was weighed out. This was added to Mixture 3 and sufficiently mixed to obtain a liquid addition-curing silicone rubber mixture.

### Formation of Primer Layer and Elastic Layer

A primer layer and an elastic layer were formed on the substrate on which the inner sliding layer was formed by the following procedure.

A hydrosilyl-based silicone primer (DY39-051 A/B; commercially available from Dow Toray Co., Ltd.) was almost uniformly applied to the outer circumferential surface of the substrate so that the dry weight was 20 mg, the solvent was dried, and a firing treatment was then performed in an electric furnace set at 160° C. for 30 minutes.

The silicone rubber mixture was applied to a thickness of 250 μm onto the primer-treated substrate by the ring coating method. This is called an uncured endless belt.

Next, a corona charging device with a charging area width of 295 mm was disposed opposite to a busbar of an uncured endless belt, and an AC electrical field was applied to the surface of the uncured elastic layer while rotating the uncured endless belt at 100 rpm. The conditions were as follows: current supplied to the discharge wire of the corona charging device: ±150 μA, voltage applied to the grid: ±1,500 V (Vp-p: 3,000 V), frequency: 0.025 Hz, charging time: 160 seconds, and distance between the grid electrode and the belt: 3 mm.

This charged uncured endless belt was heated in an electric furnace at 160° C. for 1 minute (primary curing) and then heated in an electric furnace at 200° C. for 30 minutes (secondary curing) to cure the silicone rubber mixture, and thereby an endless belt having the cured elastic layer was obtained.

### Coating of Adhesive Layer

An addition-curing silicone rubber adhesive (product name: SE1819CV A/B; commercially available from Dow Corning Toray Co., Ltd.) was applied almost uniformly to the surface of the cured elastic layer of the endless belt as an adhesive layer to a thickness of about 10 μm.

### Formation of Surface Layer

After the adhesive was applied, PFA (product name: AP-231SH; commercially available from Daikin Industries, Ltd.) was extruded and molded to form a surface layer with an inner diameter of 23 mm and a thickness of 20 μm, and the inner surface was etched to obtain a fluorine resin tube. The adhesive was covered with the fluorine resin tube by a method of performing vacuum expansion and covering from the outside (vacuum expansion coating method). Then, the belt surface was uniformly rubbed from above the fluorine resin tube, and thus an excess adhesive was squeezed out from between the elastic layer and the fluorine resin tube until the thickness was reduced to about 5 μm.

The endless belt was heated in an electric furnace set at 200° C. for 1 hour to cure the adhesive, and thus the fluorine resin tube was fixed onto the elastic layer.

Both ends of the obtained endless belt were cut to obtain a fixing film with a width of 336.5 mm.

The values of the thermal conductivity 2 of the elastic layer in the thickness direction of the prepared fixing film, the filler content, V_{A}, V_{B}, the average aspect ratios of the fillers A and B, θ_{Ave}, the thickness of the elastic layer, and the elastic modulus of the elastic layer were determined. In addition, the value V_{A+B} was calculated by dividing the sum of V_{f}'s of the fillers A and B by the sum V of V_{f}'s of all fillers. In addition, the durability was evaluated based on the following evaluation method. These results are shown in Table 2.

### Durability

The durability was evaluated using the film heating type fixing device 40 shown in FIG. 2, incorporating the prepared fixing film, according to the following evaluation.

First, the size of the contact area between the fixing film and the pressure roller was set to 10 mm in the transport direction and 330 mm in the direction perpendicular to the transport direction. Then, a profile of the pressure distribution in the fixing nip part N in the transport direction was set so that the maximum surface pressure of the recording material in the fixing nip part N in the transport direction was 0.35 MPa.

Then, evaluation was performed under the following conditions.
Test environment: a room temperature of 23 degrees, and a humidity of 50%
Process speed: 200 mm/sec
Print speed: 30 sheets/min
The surface temperature of the sheet-passing part of the fixing film: 170° C.
Sheet-passing conditions: sheets (A4-size horizontal, GF-C068) were continuously passed

If the evaluation results were A to C based on the following evaluation criteria, it was determined that the effects of the present disclosure were obtained.

### Evaluation Criteria

A: The elastic layer did not break even after 400,000 sheets or more were passed
B: The elastic layer did not break even after 300,000 sheets or more and less than 400,000 sheets were passed
C: The elastic layer did not break even after 250,000 sheets or more and less than 300,000 sheets were passed.
D: The elastic layer broke after fewer than 250,000 sheets were passed.

### Examples 2 to 16 and Comparative Examples 1 to 8

Fixing films of Examples 2 to 16, and Comparative Examples 1 to 8 were obtained in the same manner as in Example 1 except that the type of fillers used, the amount of fillers added, and the voltage applied to the grid were changed to those shown in Table 2.

In Examples 2 to 16 and Comparative Examples 1 to 8, the values of the thermal conductivity λ of the elastic layer in the thickness direction of the prepared fixing film, the filler content, V_{A}, V_{B}, the average aspect ratios of the fillers A and B, θ_{Ave}, the thickness of the elastic layer, and the elastic modulus of the elastic layer were determined. In addition, the value V_{A+B} was calculated by dividing the sum of V_{f}'s of the fillers A and B by the sum V of V_{f}'s of all fillers. In addition, the durability was evaluated based on the same evaluation method as in Example 1. These results are shown in Table 2.

TABLE 1

| | | D10 | D50 | D90 |
|---|---|---|---|---|
| Filler | Raw material | [μm] | [μm] | [μm] |
| Filler 1 | Spherical alumina particle (DAM-10) | 8.5 | 12.7 | 18.3 |
| Filler 2 | Spherical alumina particle (DAM-10) | 13.4 | 17.5 | 22.8 |
| Filler 3 | Spherical alumina particle (DAM-10) | 8.2 | 10.6 | 12.7 |
| Filler 4 | Metal silicon (Fine) | 1.4 | 4.7 | 11.6 |
| Filler 5 | Metal silicon (Fine) | 4 | 5.5 | 7.7 |
| Filler 6 | Spherical metal silicon(Fine) | 4.4 | 6 | 7.9 |
| Filler 7 | Spherical metal silicon(Fine) | 4.3 | 5.7 | 7.3 |
| Filler 8 | Spherical metal silicon(#200WB) | 9.8 | 12.6 | 15.9 |
| Filler 9 | Plate-shaped boron nitride (GP) | 4.1 | 5.5 | 7.3 |
| Filler 10 | Plate-shaped boron nitride (MGP) | 5.4 | 6.5 | 8.3 |

TABLE 2

| | | | | | | | | | | | | | | | TC | |
|---|---|---|---|---|---|---|---|---|---|---|---|---|---|---|---|---|
| | | | | | | | Filler | | | | | | | | λ | |
| Example | Filler | | Filler | | Voltage | Th | amount | V_{A} | | V_{B} | | | θ_{Ave} | EM | [W/(m · | |
| No. | No. | parts | No. | parts | [V] | μm | vol. % | vol. % | arA | vol. % | arB | V_{A+B} | [°] | [MPa] | K)] | Dur. |
| 1 | 3 | 98.7 | 10 | 43.9 | ±1500 | 250 | 30 | 15 | 9.1 | 15 | 1.4 | 0.99 | 21 | 0.80 | 1.68 | A |
| 2 | 3 | 40.4 | 10 | 16.9 | ±1000 | 250 | 15 | 7 | 9.1 | 7 | 1.3 | 0.98 | 17 | 0.72 | 1.44 | A |
| 3 | 3 | 77.5 | 10 | 33.8 | ±1400 | 250 | 25 | 13 | 9.1 | 12 | 1.4 | 0.98 | 18 | 0.75 | 1.52 | A |
| 4 | 3 | 227.5 | 10 | 104.1 | ±2400 | 250 | 50 | 26 | 9.1 | 24 | 1.4 | 0.99 | 28 | 0.90 | 1.78 | C |
| 5 | 3 | 125.6 | 10 | 120.5 | ±2300 | 250 | 45 | 30 | 9.6 | 15 | 1.7 | 0.99 | 26 | 0.88 | 1.77 | C |
| 6 | 1 | 254.9 | 10 | 45.2 | ±2200 | 250 | 45 | 15 | 7.7 | 30 | 1.2 | 0.97 | 27 | 0.86 | 1.62 | C |
| 7 | 3 | 115.1 | 10 | 90.7 | ±2100 | 250 | 40 | 25 | 9.5 | 15 | 1.6 | 0.99 | 26 | 0.85 | 1.68 | B |
| 8 | 2 | 169.3 | 10 | 59.2 | ±2100 | 250 | 40 | 15 | 10.0 | 25 | 1.7 | 0.99 | 25 | 0.84 | 1.58 | B |
| 9 | 2 | 87.1 | 5 | 52.3 | ±1200 | 250 | 30 | 15 | 5.0 | 15 | 1.4 | 0.99 | 24 | 0.78 | 1.48 | A |
| 10 | 3 | 139.3 | 6 | 20.9 | ±1200 | 250 | 30 | 10 | 3.0 | 20 | 1.1 | 0.99 | 22 | 0.77 | 1.45 | A |
| 11 | 3 | 121.9 | 9 | 30.4 | ±1500 | 250 | 30 | 12 | 40.0 | 18 | 1.3 | 0.99 | 28 | 0.88 | 1.65 | C |
| 12 | 2 | 104.5 | 4 | 41.8 | ±1500 | 250 | 28 | 8 | 5.0 | 20 | 2.0 | 0.95 | 23 | 0.77 | 1.50 | A |
| 13 | 3 | 98.7 | 10 | 43.9 | ±1000 | 250 | 30 | 15 | 9.1 | 15 | 1.4 | 0.98 | 45 | 0.81 | 1.40 | A |
| 14 | 3 | 98.7 | 10 | 43.9 | ±1200 | 250 | 30 | 15 | 9.1 | 15 | 1.4 | 0.99 | 40 | 0.79 | 1.42 | A |
| 15 | 3 | 41.0 | 6 | 17.8 | ±500 | 250 | 15 | 7 | 3.3 | 7 | 1.1 | 0.98 | 45 | 0.71 | 1.31 | A |
| 16 | 3 | 235.6 | 6 | 102.5 | ±1300 | 250 | 50 | 25 | 3.3 | 25 | 1.1 | 0.99 | 45 | 0.91 | 1.35 | C |
| C.E. 1 | 3 | 297.9 | 10 | 115.7 | ±2400 | 250 | 55 | 27 | 9.0 | 28 | 1.3 | 0.98 | 32 | 0.96 | 1.70 | D |
| C.E. 2 | 3 | 140.6 | 10 | 136.5 | ±2400 | 250 | 48 | 32 | 9.6 | 16 | 1.7 | 0.99 | 31 | 0.92 | 1.72 | D |
| C.E. 3 | 3 | 296.9 | 10 | 45.5 | ±2400 | 250 | 48 | 16 | 7.8 | 32 | 1.2 | 0.98 | 28 | 0.9 | 1.62 | D |
| C.E. 4 | 3 | 87.1 | 7 | 52.3 | ±1500 | 250 | 30 | 17 | 2.2 | 13 | 1.1 | 0.99 | 15 | 0.77 | 1.13 | A |
| C.E. 5 | 8 | 69.7 | 10 | 33.8 | ±1500 | 250 | 30 | 10 | 9.7 | 20 | 2.4 | 0.99 | 22 | 0.88 | 1.52 | D |
| C.E. 6 | 2 | 139.5 | 9 | 35.3 | ±1500 | 250 | 33 | 10 | 44.0 | 23 | 1.9 | 0.99 | 29 | 0.87 | 1.65 | D |
| C.E. 7 | 2 | 34.9 | 9 | 13.8 | ±900 | 250 | 13 | 6 | 9.0 | 6 | 1.3 | 0.97 | 17 | 0.68 | 1.18 | A |
| C.E. 8 | 3 | 98.7 | 10 | 43.9 | ±750 | 250 | 30 | 15 | 9.1 | 15 | 1.4 | 0.98 | 50 | 0.77 | 1.08 | A |

In the tables, C.E. indicates “Comparative Example”, “parts” of the filler indicates “Addition amount [parts by mass]”, and the voltage is a voltage applied to the grid. “Th” indicates “Thickness of elastic layer”. The filler amount is the content of the fillers in the elastic layer. “vol. %” indicates Volume %. arA is the average aspect ratio of the filler A, and arB is the average aspect ratio of the filler B. “EM” indicates “Elastic modulus of elastic layer”, and “TC” indicates “Thermal conductivity”, and “Dur.” indicates “Durability evaluation”.

According to the present disclosure, it is possible to provide an electrophotographic member having high thermal conductivity and high durability in which the elastic layer is less likely to break even after long-term use under conditions in which the maximum surface pressure in the fixing nip part is higher than in the past. In addition, according to the present disclosure, it is possible to provide a fixing device and an electrophotographic image forming apparatus which include the electrophotographic member.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-021260, filed Feb. 13, 2025, and Japanese Patent Application No. 2026-001437, filed Jan. 7, 2026, which are hereby incorporated by reference herein in their entirety.

What is claimed is:

1. An electrophotographic member which is a rotating member comprising a substrate and an elastic layer provided on the outer circumference of the substrate,
wherein the elastic layer comprises a rubber and fillers dispersed in the rubber,
content of the fillers in the elastic layer is 15 to 50 volume %,
when among the fillers, one having a particle diameter of 3 μm or more and less than 10 μm is defined as a filler A, and
one having a particle diameter of 10 to 40 μm is defined as a filler B,
content V_{A} of the filler A in the elastic layer is 7 to 30 volume %,
average aspect ratio of the filler A is 3.0 to 40.0,
content V_{B} of the filler B in the elastic layer is 7 to 30 volume %,
average aspect ratio of the filler B is 1.0 to 2.0,
when a plane of the elastic layer in a thickness-circumferential direction is defined as a first plane, and planes rotated from the first plane in increments of 10° toward the plane of the elastic layer in a thickness-axial direction are defined as second to tenth planes,
cross-sectional images having a size corresponding to full thickness of the elastic layer×500 μm are acquired as first to tenth cross-sectional images such that each image is parallel to the first to tenth planes, and the center in a direction perpendicular to the thickness direction of the elastic layer matches the center of the electrophotographic member in the axial direction,
the first to tenth cross-sectional images are binarized to form first to tenth binarized images, and
in the first to tenth binarized images, when shapes of the fillers are approximated as ellipses,
the fillers, which are approximately ellipses and have a major axis length/minor axis length value of 2.0 or more, have an average orientation angle θ_{Ave} of 0° to 45° relative to the thickness direction of the elastic layer.

2. The electrophotographic member according to claim 1, wherein the filler A comprises a flat-plate-shaped filler.

3. The electrophotographic member according to claim 1, wherein the average orientation angle θ_{Ave} is 0° to 40°.

4. The electrophotographic member according to claim 1, wherein the average aspect ratio of the filler A is 5.0 to 40.0.

5. The electrophotographic member according to claim 1,
wherein the content of the fillers in the elastic layer is 25 to 45 volume %,
the content V_{A} is 12 to 25 volume %, and
the content V_{B} is 12 to 25 volume %.

6. The electrophotographic member according to claim 1, wherein the thermal conductivity of the elastic layer in the thickness direction is 1.40 W/(m·K) or more.

7. The electrophotographic member according to claim 1, wherein the filler A contains flat-plate-shaped boron nitride.

8. The electrophotographic member according to claim 1, wherein elastic modulus of the elastic layer is 0.60 to 2.00 MPa.

9. The electrophotographic member according to claim 1, wherein thickness of the elastic layer is 150 to 500 μm.

10. The electrophotographic member according to claim 1, wherein the electrophotographic member is a fixing member.

11. A fixing device, comprising:
a fixing member; and
a pressure member that faces the fixing member and forms a fixing nip part between the pressure member and the fixing member, through which a recording material carrying a toner image is nipped and transported,
wherein at least one of the fixing member and the pressure member is the electrophotographic member according to claim 1.

12. The fixing device according to claim 11, wherein maximum surface pressure of the recording material in a transport direction in the fixing nip part is 0.25 to 0.40 MPa.

13. An electrophotographic image forming apparatus comprising a fixing device, wherein the fixing device is the fixing device according to claim 11.
